(19) United States
(12) Patent Application Publication
(10) Pub. No.: US 2011/0284591 A1
(43) Pub. Date: Nov. 24, 2011

(54) GREASE GUN WITH A REMOVABLE ROTARY TOOL

(76) Inventor: WEN-I GUO, Taichung County (TW)

(21) Appl. No.: 13/195,011

(22) Filed: Aug. 1, 2011

Related U.S. Application Data
(63) Continuation-in-part of application No. 12/183,041, filed on Jul. 30, 2008.

(51) Int. Cl. G01F 11/00

(52) U.S. Cl. 222/333

(57) ABSTRACT

A grease gun with a removable rotary tool comprises a connecting rod, a transmission mechanism, a push rod, and a connecting. The rotary tool which serves as a power source is removably mounted outside the body of the grease gun in such a manner that a connecting rod extends out of the body, such that the body is independent from the power source. The present invention can really save money for the consumers since the consumers only have to buy the body when need a grease gun, and the grease gun manufacturers don't need to produce the rotary tool F when producing grease gun, thus saving manufacturing cost.

This application is a continuation of part of U.S. patent application Ser. No. 12/183,041. Claim 1 of this application is revised from claim 1 of the U.S. patent application Ser. No. 12/183,041, and claims 2-4 correspond to claims 2-4 of the U.S. patent application Ser. No. 12/183,041.

### BACKGROUND OF THE INVENTION

1. Field of the Invention

The present invention relates to a lubricating pump for lubricating purpose, and more particularly to a grease gun with a removable rotary tool.

2. Description of the Prior Art

Referring to FIG. 1, a conventional electric grease gun disclosed in Taiwan Serial No. 087,216,110 is shown, a motor 90 is disposed in the grease gun, a transmission mechanism 80 is used to transmit the power of the motor 90 to a push rod 70, so as to make the push rod 70 move axially and reciprocatedly, thus extruding the grease in a grease cylinder 60 from an outlet 50. Thereby, the effect of extruding the grease by power is obtained.

Since such an electric grease gun utilizes its motor as a power source, the manufacturing cost is increased, so that the spending of the consumer is increased. Currently, families often use different kinds of automatic tools, such as, pneumatic or electric rotary tools, if such automatic tools all need to be provided with a power source, it will cause a burden to the consumer.

Therefore, a grease gun used by cooperating with a rotary tool which can reduce the manufacturing cost and the spending of the consumer is developed.

The present invention has arisen to mitigate and/or obviate the afore-described disadvantages.

### SUMMARY OF THE INVENTION

The primary objective of the present invention is to provide a grease gun with a removable rotary tool, wherein the rotary tool which serves as a power source is removably mounted outside the body of the grease gun in such a manner that a connecting rod extends out of the body, such that the body is independent from the power source. The present invention can really save money for the consumers since the consumers only have to buy the body when need a grease gun, and the grease gun manufacturers don't need to produce the rotary tool F when producing grease gun, thus saving manufacturing cost.

To achieve the objective of the present invention, the grease gun comprises a housing assembly, a body consisting of a housing assembly, a transmission mechanism, a push rod and a connecting rod. The transmission mechanism and the push rod are disposed in the housing assembly, the push rod is connected to and driven by the transmission mechanism to reciprocatedly push a grease cylinder mounted on the housing assembly to output grease, the connecting rod has one end inserted in the housing assembly to engage with the transmission mechanism and has another end extending out of the housing assembly.

The rotary tool is removably engaged with the another end of the connecting rod extending out of the housing assembly to drive the connecting rod to rotate, so as to actuate the transmission mechanism.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a conventional electric grease gun;

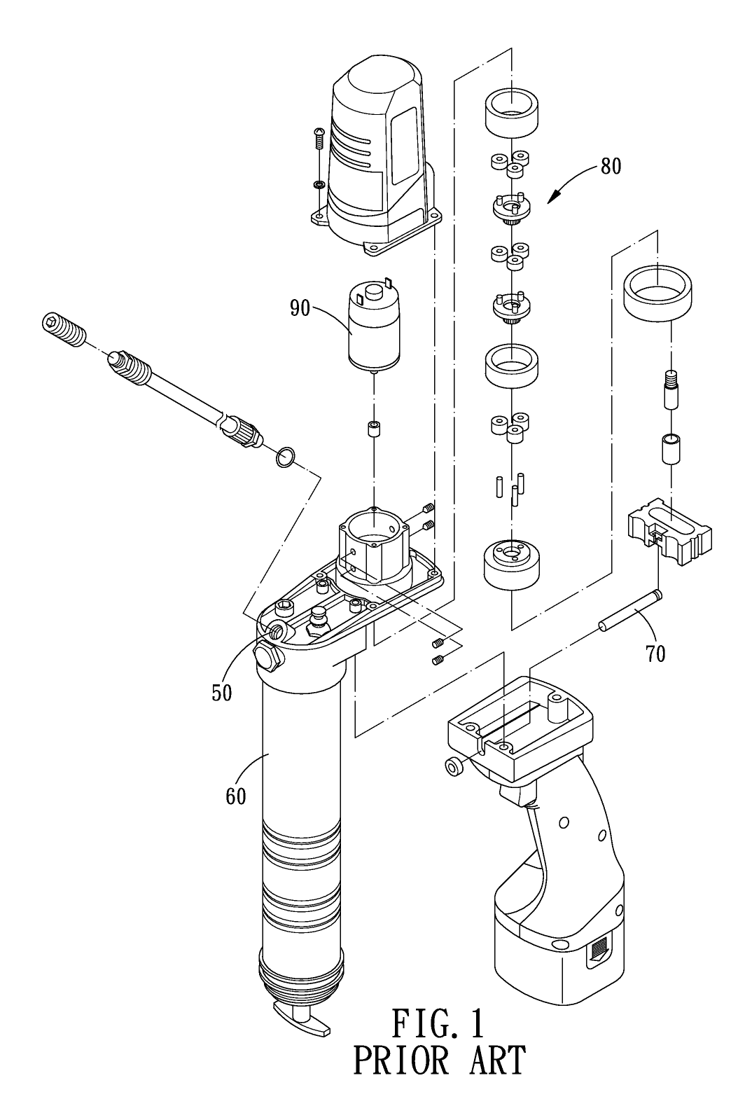

FIG. 2 is an exploded view of a transmission mechanism and a connecting rod in accordance with the present invention;

FIG. 3 is an assembly perspective view of the transmission mechanism and the connecting rod in accordance with the present invention;

FIG. 4 is an exploded view of a push rod and a housing assembly in accordance with the present invention;

FIG. 5 is a perspective view of a grease gun with a removable rotary tool in accordance with the present invention; and

FIG. 6 is an illustrative view showing the operation of the grease gun with a removable rotary tool in accordance with the present invention.

### DETAILED DESCRIPTION OF THE PREFERRED EMBODIMENTS

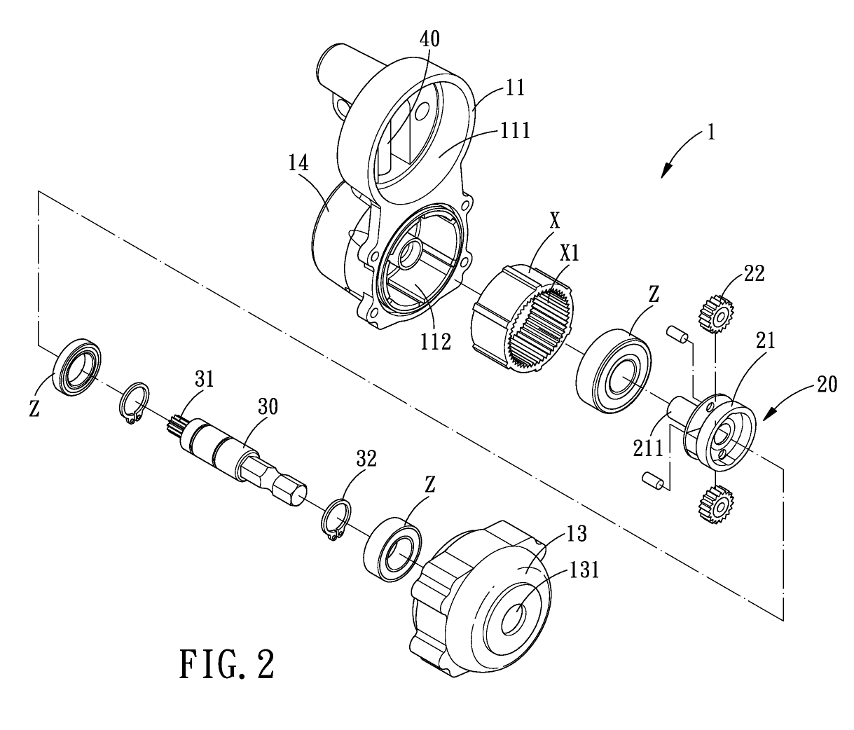

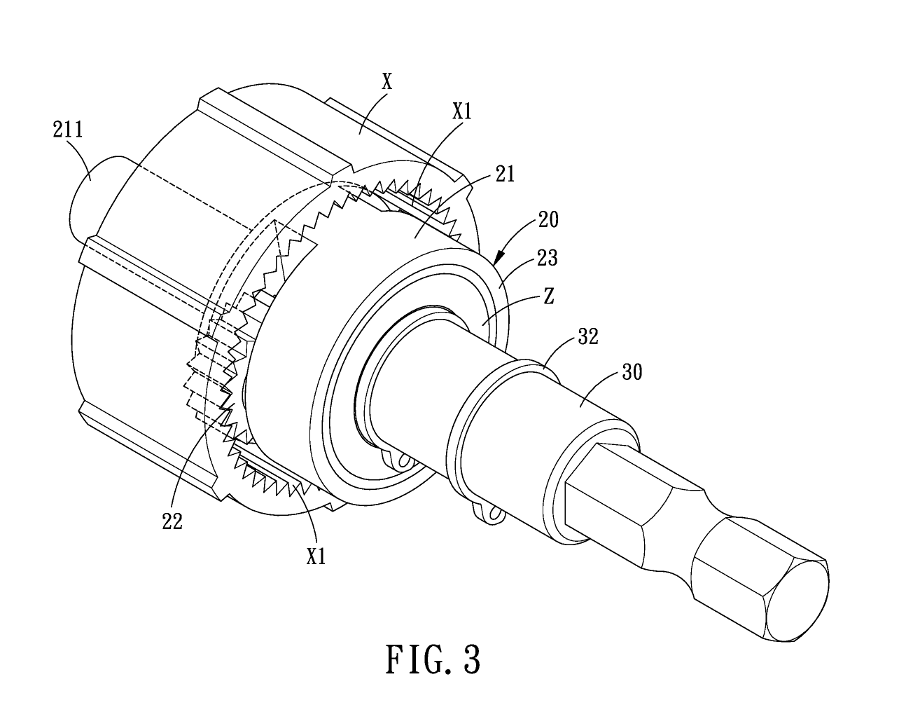

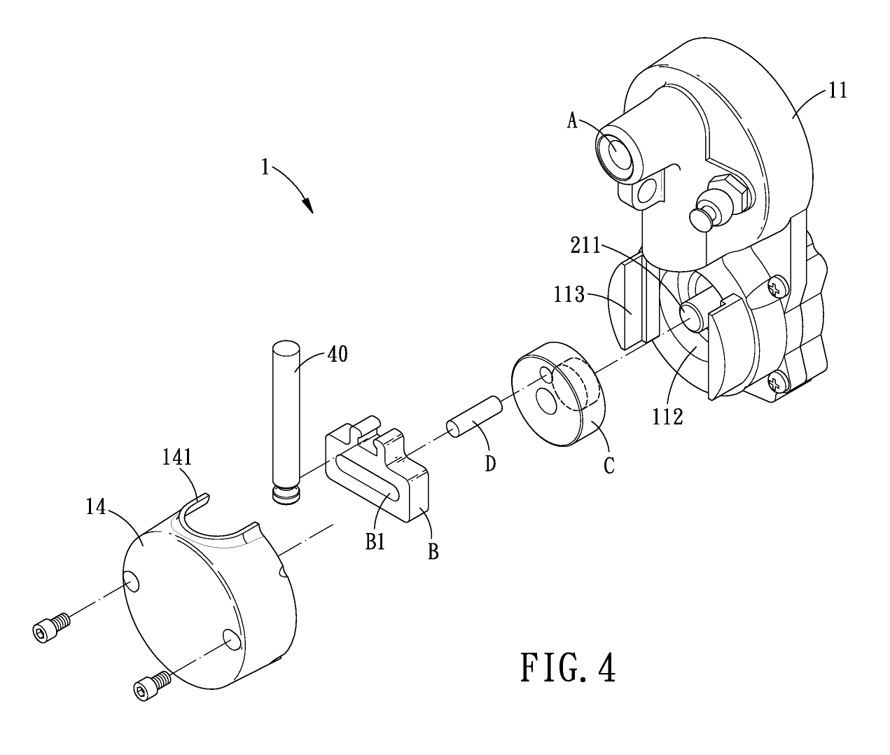

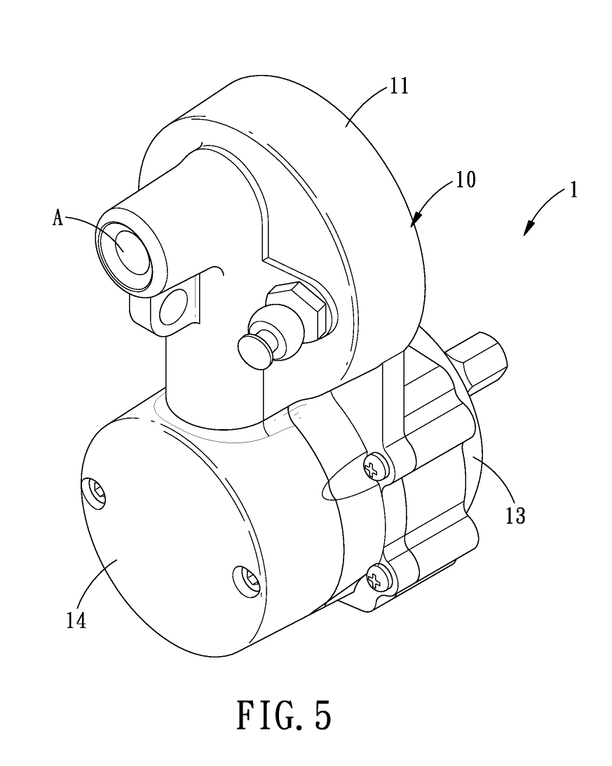

Referring to FIGS. 2-5, a grease gun used with a removable rotary tool in accordance with the present invention comprises a body 1 consisting of a housing assembly 10, a transmission mechanism 20, a connecting rod 30 and a push rod 40.

The housing assembly 10 comprises a housing 11, a first cover 13 and a second cover 14. The housing 11 is defined with a first space 111, a second space 112 and a slide way 113. The first space 111 is defined with an outlet A. A bearing Z1 and a mounting ring X having inner teeth X1 are disposed in the second space 112. The first cover 13 is located correspondingly to the second space 112 and is assembled with the housing 11. The first cover 13 is defined with a through hole 131, and a bearing Z2 is disposed in the first cover 13 and located opposite to the through hole 131. The second cover 14 is assembled with the housing 11 and covers the slide way 113 of the housing 11. The second cover 14 is defined with a notch 141.

The transmission mechanism 20 is disposed in the housing assembly 10, and is provided with a pivot seat 21 and two planetary gears 22. One end of the pivot seat 21 is provided with a pivot shaft 211 which is inserted in the bearing Z1 of the second space 112 of the housing 11. The planetary gears 22 are pivotally disposed on the pivot seat 21. The planetary gears 22 are laterally protruded out of the pivot seat 21 and are engaged with the inner teeth X1 of the mounting ring X disposed in the second space 112 of the housing 11. The other end of the pivot seat 21 is provided with a bearing Z3.

One end of the connecting rod 30 is provided with a gear 31 which is passed through the bearing Z3 of the pivot seat 21 and is engaged with the planetary gears 22, and the other end of the connecting rod 30 is protruded out of the housing assembly 10 of the body 1 by passing through the bearing Z2 and the through hole 131 of the first cover 13. The connecting rod 30 is radially provided with two retaining rings 32 which are abutted against the bearing Z3 of the pivot seat 21 and the bearing Z2 of the first cover 13, so as to restrict the connecting rod 30.

One end of the push rod 40 is assembled to a slide block B. The slide block B is defined with an elongated inserting hole B1 and is slidably disposed in the slide way 113 of the housing 11. The other end of the push rod 40 is inserted in the first space 111 of the housing 11 by passing through the notch 141 of the second cover 14. A rotating disc C is mounted on the pivot shaft 211 of the pivot seat 21 of the transmission mechanism 20 and is eccentrically provided with a protruding pole D, and the protruding pole D is inserted in the inserting hole B1 of the slide block B.

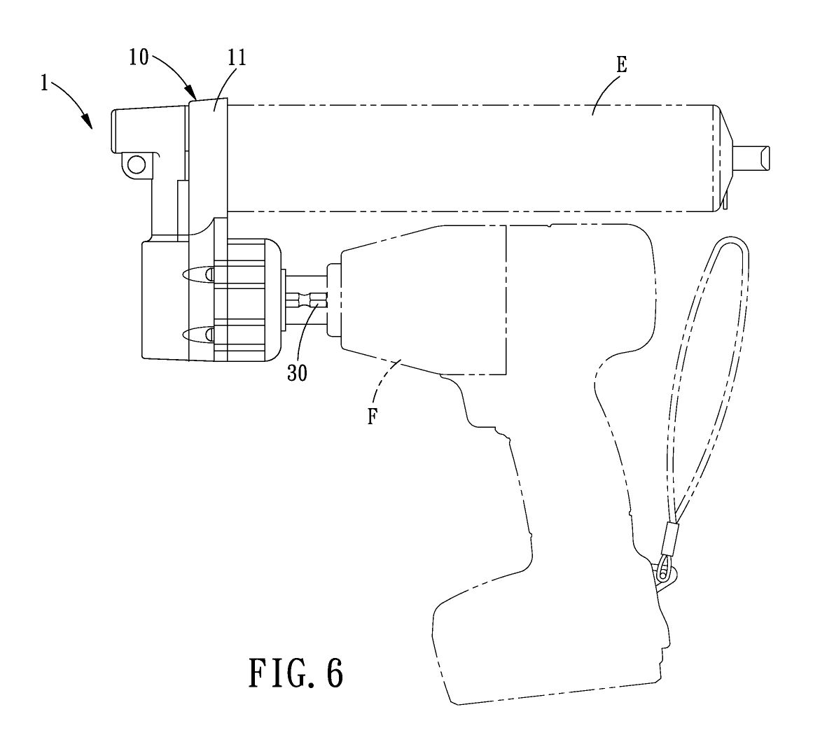

Referring to FIG. 6, when in use, a grease cylinder E is disposed on the housing 11 of the housing assembly 10 of the body 1 and is in communication with the first space 111 of the housing 11. The other end of the connecting rod 30 which is protruded out of the first cover 13 is connected to a rotary tool F. The rotary tool F drives the connecting rod 30 to rotate, and then the gear 31 of the connecting rod 30 rotates the planetary gears 22 of the transmission mechanism 20. Since the planetary gears 22 are engaged with the mounting ring X disposed in the second space 112 of the housing 11, the pivot seat 21 will rotate, and the pivot shaft 211 of the pivot seat 21 will drive the rotating disc C to rotate. Thereby, the protruding pole D disposed on the rotating disc C eccentrically rotates, which allows the protruding pole D to move in the inserting hole B1 of the slide block B to and fro and to drive the slide block B to move in the slide rail 113 of the housing 11 to and fro. Moreover, the slide block B drives the push rod 40 to move axially and reciprocatedly, such that the push rod 40 will extrude the grease in the grease cylinder E from the outlet A of the first space 111 of the housing 11.

It is apparent from the above-mentioned descriptions that the grease gun can output grease when driven by a power source, namely the rotary tool F, the body 1 of the present invention is an independent device only with one end of the connecting rod 30 extending out of the body 1, so it is unnecessary to provide an additional power source in the body 1, and the grease gun of the present invention can be used in cooperation with any household electric or pneumatic rotary tool F simply by removably connecting the end of the connecting rod 30 exposed out of the body 1 to the rotary tool F. The present invention can really save money for the consumers since the consumers only have to buy the body 1 when need a grease gun, and the grease gun manufacturers don't need to produce the rotary tool F when producing grease gun, thus saving manufacturing cost.

While we have shown and described various embodiments in accordance with the present invention, it should be clear to those skilled in the art that further embodiments may be made without departing from the scope of the present invention.

What is claimed is:

1. A grease gun with a removable rotary tool, comprising:
a body consisting of a housing assembly, a transmission mechanism, a push rod and a connecting rod, the transmission mechanism and the push rod being disposed in the housing assembly, the push rod being connected to and driven by the transmission mechanism to reciprocatedly push a grease cylinder mounted on the housing assembly to output grease, the connecting rod having one end inserted in the housing assembly to engage with the transmission mechanism and having another end extending out of the housing assembly;
the rotary tool being removably engaged with the another end of the connecting rod extending out of the housing assembly to drive the connecting rod to rotate, so as to actuate the transmission mechanism.

2. The grease gun with a removable rotary tool as claimed in claim 1, wherein the connecting rod is radially provided with two retaining rings which are abutted against the transmission mechanism and the first cover of the housing assembly, so as to restrict the connecting rod.

3. The grease gun with a removable rotary tool as claimed in claim 1, wherein the transmission mechanism is provided with a pivot seat and two planetary gears, one end of the pivot seat is provided with a pivot shaft which is connected to the push rod and drives the push rod to move in the slide way axially and reciprocatedly, the planetary gears are pivotally disposed on the pivot seat, the planetary gears are laterally protruded out of the pivot seat and are engaged with the inner teeth of the mounting ring disposed in the housing assembly, and the planetary gears are also engaged with the gear of the connecting rod.

4. The grease gun with a removable rotary tool as claimed in claim 3, wherein one end of the push rod is assembled to a slide block, the slide block is slidably disposed in the slide way of the housing assembly and is defined with an elongated inserting hole, a rotating disc is mounted on the pivot shaft of the pivot seat of the transmission mechanism and is eccentrically provided with a protruding pole, and the protruding pole is inserted in the inserting hole of the slide block.
